(19) United States
(12) Patent Application Publication
(10) Pub. No.: US 2024/0408615 A1
(43) Pub. Date: Dec. 12, 2024

(54) AMBIENT AIR PURIFIER WITH OZONE CATALYST

(71) Applicant: WOCO GmbH & Co. KG, Bad Soden-Salmünster (DE)

(72) Inventors: Anton Wolf, Gelnhausen Haitz (DE); Michael Dietzen, Sankt Augustin (DE)

(73) Assignee: WOCO GmbH & Co. KG, Bad Soden-Salmünster (DE)

(21) Appl. No.: 18/697,582

(22) PCT Filed: Sep. 26, 2022
(86) PCT No.: PCT/EP2022/076695

§ 371 Date: Apr. 1, 2024

(30) Foreign Application Priority Data
Oct. 1, 2021 (DE) 10 2021 125 570.8

(51) Int. Cl. B03C 3/017; B01D 53/86; B03C 3/16

(52) U.S. Cl. CPC B03C 3/017; B01D 53/8675; B03C 3/16; B01D 2255/1021; B01D 2255/1023; B01D 2255/106; B01D 2255/2073; B01D 2257/106; B01D 2258/06

(57) ABSTRACT

The present invention relates to an ambient air purifier comprising an electric precipitator having a counter electrode and an emission electrode and is designed to precipitate liquid and/or solid particles from air to be purified while generating ozone, and a catalyst arranged downstream of the electric precipitator in the air flow direction for decomposing at least part of generated ozone.

The present invention relates to an apparatus, namely an ambient air purifier, and a method for treating, in particular humidifying, purifying and/or washing, air, such as a humidifier, an air purifier, an air washer or the like.

Generic ambient air purifiers, also known as air treatment devices, are designed to treat, in particular purify, humidify and/or wash air present in closed rooms and/or buildings. The air treatment devices can have numerous areas of application, for example in medical technology or in the healthcare industry, in particular in doctors' offices, isolation rooms, hospital rooms, intensive care units or clean rooms, in private households, in particular in bedrooms, living rooms, kitchens or children's rooms, in public or industrial buildings, such as museums, theaters, government buildings or offices, and/or in mobility, for example for cleaning vehicle interiors, in particular in cabs, rental cars or vehicle sharing concepts. For example, the air treatment devices are floor-standing appliances and/or small electrical appliances that can be placed on the floor or on shelves, such as tables, in buildings or rooms.

Ambient air purifiers are usually equipped with multi-layer filter systems. A highly effective HEPA filter is supplemented by additional filters so that ambient air drawn in is cleaned and freed of pollutants. Air washers, on the other hand, generally work without additional filters and guide air through a water bath, where it is cleaned and humidified at the same time.

Ever higher demands are being placed on air treatment. This is due on the one hand to increasingly stringent legal requirements and on the other to the population's growing health awareness. In particular, the particulates present in the air, which contains solid particles in the μg/m³ range, has proven to be particularly critical. Particulates can further contain bacteria, pollen, viruses, spores, fibers and the like. There are generally two types of air treatment devices, namely passive air treatment devices and active air treatment devices. With passive air treatment devices, no additional energy is introduced into the system to treat air. Active air treatment devices are characterized by the fact that additional energy is used to perform air treatment. Known air treatment devices are limited in their effectiveness in terms of air treatment. Passive systems in particular are not capable of effectively separating particulates from the air.

In the state of the art, there are already approaches for air treatment devices in which electric precipitation technology is used. However, such systems have the fundamental disadvantage that dry particles and thus non-aerosols are difficult to collect on a counter electrode and transport away. Particulates are either carried away again by the air flow after contact with the counter electrode or “clump together” to form a non-electrically conductive mass on the counter electrode. This means that, on the one hand, the precipitation efficiency is heavily dependent on the aerodynamics of the air flow, and, on the other hand, the function of the counter electrode suffers due to the reduction in its necessary electrical conductivity.

When operating ambient air purifiers with electrostatic precipitators (electric filters), ozone can be formed either intentionally or unintentionally. For this reason, ozone is generally not generated in ventilation systems. The German Lung Foundation, for example, warns against using ozone-generating air purifiers to eliminate the bad odor of smoky rooms. The guideline VDI 6022 Sheet 5 “Indoor air technology, indoor air quality—Avoidance of allergenic loads—Requirements for testing and evaluation of technical devices and components with influence on breathing air” therefore recommends determining the ozone emission rate when using ionizers, if necessary.

In principle, various ozone decomposition systems are known. These can be of a thermal nature, for example by applying heat of at least 50 to 60° C., which represents an additional energy requirement, based on the use of activated carbon, which has the disadvantage that activated carbon filters have a delimiting service life as they decompose and have to be renewed, or have a catalytic effect. A plasma-based air purifier with a catalytic ozone decomposition system is described in EP 2 774 628 A1, according to which generated ozone can be decomposed via a downstream filter with a catalyst coating.

Such air purification systems have the fundamental disadvantage that dry particles and thus non-aerosols are difficult to collect on a counter electrode and transport away. Particulates are either carried away again by the air flow after contact with the counter electrode or “clump together” to form a non-electrically conductive mass on the counter electrode. This means that, on the one hand, the degree of precipitation is heavily dependent on the aerodynamics of the air flow, and, on the other hand, the function of the counter electrode suffers due to the reduction in its necessary electrical conductivity. In EP 2 774 628 A1, the sandwich arrangement of emission electrode, catalyst and counter-electrode also proved to be detrimental to the precipitation efficiency. Furthermore, in EP 2 774 628 A1 charged ions enter the atmosphere unhindered.

It is the task of the present invention to overcome the disadvantages of the known prior art, in particular to provide an ambient air purifier with improved precipitation efficiency.

This task is solved by the features of the independent claims.

Accordingly, an ambient air purifier for purifying, humidifying and/or washing air is provided. The air may, for example, be provided with solid and/or liquid particles, in particular contamination, which can be at least partially separated from the air by means of the ambient air purifier according to the invention. The air is in particular air which is present in closed rooms and/or buildings, such as ambient air, and with which people can come into direct contact. For example, the ambient air purifier is a small electrical appliance and/or a stand-alone appliance which can be installed in buildings or rooms, or which can be integrated into a room and/or building ventilation system, such as a vehicle interior ventilation system. In addition to the possibility that the ambient air purifier can be formed as a stand-alone device, in particular a free-standing device, it is also possible to integrate the ambient air purifier according to the invention into ventilation systems, extractor hoods or other ventilation systems arranged in a room of a building or a room of a car. The ambient air purifier can be capable of removing liquid particles, such as grease or oil particles, as well as fine dust solid particles from the air, even for solid particle concentrations in the μg/m³ portion. In particular, the ambient air purifier is able to comply with the particulates threshold values, wherein, for example, a particulates threshold value PM10 of 40 μg/m³ can be achieved. Particulates are understood to be particles with an aerodynamic diameter of 10 μm or smaller.

An ambient air purifier according to the invention comprises an electric precipitator with a counter electrode and an emission electrode for separating liquid and/or solid particles from air to be treated. The emission electrode can, for example, be formed as an array of emission electrodes. The emission electrodes can be formed as emission electrode needles. The electric precipitator is designed to separate solid and/or liquid particles from air to be cleaned by generating ozone and, in particular, to eliminate unpleasant odors.

The electric precipitator can be formed as a plasma precipitator. The counter electrode and the emission electrode can be insulated from each other and/or each made from a single piece. The emission electrode, also known as the spray electrode, is essentially designed to emit in particular negatively charged particles. The counter electrode, also known as the collecting electrode, forms the opposite pole. For example, the space between the emission electrode and the counter electrode can be referred to as precipitator space, in which solid and/or liquid particles are precipitated from air to be treated. During operation of the electric precipitator, a high electrical voltage is applied between the emission electrode and the counter electrode. For example, the high voltage is in the range of 8 to 16 kV, in particular in the range of 11 to 14 kV. In particular, the electric precipitator is operated below the breakdown or flashover voltage. Breakdown voltage, also known as flashover voltage, is the voltage that must be exceeded for a voltage breakdown to occur through a material or substance, for example an insulator or gas. For example, the principle of charge generation on which the electric precipitator is based can be impact ionization. When the so-called corona field strength is exceeded, electrons leave the emission electrode and interact with the surrounding air molecules, forming a so-called negative corona. Free electrons present in the air are strongly accelerated in the electrostatic field of the corona, so that a gas discharge can occur. When the free electrons hit air molecules, further electrons can be split off or attach themselves to air molecules. The negative charges then move in the direction of the neutrally charged counter electrode. The counter electrode can, for example, be grounded and/or at ground potential. When a particle-laden gas stream enters, the negatively charged charges accumulate on the particles. The electrostatic force of the DC voltage field, which can be oriented transversely to the direction of air flow through the ambient air purifier, causes the negatively charged particles to migrate towards the counter electrode, where they can dispense their charge and be removed from the counter electrode. In this way, the particles can be separated from the air stream. The present invention also covers embodiments in which a positive corona or a positively charged charge is generated instead of the negative corona or the negatively charged charges. To avoid repetition, the description of the invention is limited to the embodiment of the negative charge situation.

The ambient air purifier may comprise an air conveying device, in particular an air intake device, such as a fan. A fan is generally understood to be a flow machine that builds up a pressure ratio of between 1 and 1.3 between the intake and pressure side in order to convey air. The air conveying device can be configured to draw in air from the surroundings and/or to convey air towards the electric precipitator. In particular, the air conveying device is capable of or provided for drawing air to be treated, in particular building and/or ambient air, into the ambient air purifier and feeding it to or exposing it to the electric precipitator in order to subject the air to be treated to an electric precipitation process, to separate solid and/or liquid particles from the air to be treated and thus to purify the air to be treated. The air conveying device can be arranged in such a way that air drawn in reaches velocities in the range of 2 m/s to 10 m/s. After passing through the electric precipitator, the electrically charged air can flow, in particular be transported, through the ambient air purifier at flow velocities in the range of 0.1 m/s to 0.5 m/s.

The electric precipitator can generate a stable DC plasma at a high-voltage electrical field of the electric precipitator in the range of 8 kV to 16 kV. The plasma current at the emission electrodes can be between 4 μA and 10 μA. Due to the in particular negative charges generated in the electric precipitator, at least some of the oxygen (O2) contained in air to be purified is split into individual oxygen atoms, which can then combine to form ozone (O3). The electric precipitator generates ozone as a by-product, in particular when generating a plasma. The higher the voltage between the emission electrode and the counter electrode, the more ozone is generated as a by-product in the electric precipitator. The ozone can remove unpleasant odors from air to be treated and/or disinfect it.

In order to break down at least some of the ozone generated by the electric precipitator so that it does not enter the environment, the ambient air purifier according to the invention comprises a catalyst downstream of the electric precipitator in the air flow direction. A decisive advantage of the ambient air purifier according to the invention is that the catalyst arranged according to the invention does not impair the electric precipitator, in particular the ionization process of air, so that the degree of precipitation is increased compared to the state of the art, wherein at the same time the spread of harmful ozone into the surroundings is avoided. For example, the catalyst is not connected directly downstream of the electric precipitator, i.e. at a short distance from it, but a significant distance behind it, so that it can be reliably ruled out that the electric precipitation process is impaired. The catalyst reduces the ozone concentration in the treated air by means of a catalytic process or reaction and thus reduces the health risk of the ambient air purifier according to the invention. The catalytic effect of the catalyst causes generated ozone to be split, resulting in oxygen molecules that are harmless to health. In this respect, a particularly easy-to-produce ambient air purifier with reduced health risk and improved precipitation efficiency is provided, which is characterized in particular by a space-saving, flexible and/or cost-effective property.

According to an exemplary further development of the ambient air purifier, it comprises a particularly rotational air guide which is configured to guiding air to be treated and ozone-enriched from the electric precipitator to the catalyst. For example, the air guide is formed in such a way that air is deflected by at least 10°, 30°, 45°, 60° or about 90° on its way to the catalyst. According to an exemplary further development, the air guide has a deflector body arranged in particular in the rotation center of the air guide, which is arranged to deflect air treated by the electric precipitator against the direction of gravity. For example, air can flow into the ambient air purifier evenly on all sides and be guided and/or fed to the electric precipitator in a targeted manner in order to clean the air. The cleaned air is then guided further, in particular in the direction of the rotation center by means of the air guide, deflected at the deflector body and guided back out of the ambient air purifier against the direction of gravity, i.e. upwards. The inventors have discovered that air at the side of the ambient air purifier contains a particularly large number of particles, in other words is particularly heavily contaminated, so that particularly heavily contaminated air flows into the ambient air purifier through an air inlet at the side and a particularly large number of particles can be precipitated from the air. In this way, the entire ambient air can be cleaned particularly effectively and quickly. The upward air outlet has the advantage that people in the vicinity of the ambient air purifier are not blown by the air exiting the ambient air purifier. According to an exemplary further development, the deflector body is shaped in such a way that treated air is essentially deflected in the direction of the axis of rotation defined by its center, in particular the rotation center of the air guide. According to another exemplary further development, the deflector body is formed in a rotational shape. It may be provided that the deflector body has a gyroscopic shape. Alternatively or additionally, the deflector body has a in particular circumferential deflection surface that is, at least sectionally, concave, on which the cleaned air is deflected against the direction of gravity, i.e. upwards. The cleaned air can be deflected particularly evenly and reliably by a rotationally shaped deflector body. The deflector body can be, at least sectionally, curved, in particular curved, preferably concavely curved, in such a way that air flows laminar against it so that turbulence, such as swirls, can be prevented.

According to a further exemplary embodiment of the ambient air purifier according to the invention, the catalyst has a reticular carrier, which can, for example, have an in particular fine-meshed honeycomb structure or honeycomb shape and/or is provided with a catalytically active coating, such as a noble metal or manganese dioxide coating. Noble metals such as platinum, gold or palladium have proven to be particularly effective. The catalytically active coating or substance can be designed to achieve significant reductions in ozone content in the air even at normal ambient temperature and/or with single-layer reticular carriers.

In a further exemplary embodiment of the present invention, the reticular carrier is a fine-meshed expanded metal or an electrically conductive plastic net, which is coated with metal, for example.

In a further exemplary embodiment, the coating is applied to the carrier by means of a gas- or solution-based deposition process. For example, wet-chemical deposition, chemical vapor deposition (CVD) or physical vapor deposition (PVD) can be used. Alternatively, the coating can be sputtered on.

According to an exemplary further development of the present invention, the ambient air purifier comprises a discharge system downstream of the electric precipitator in the air flow direction and upstream of the catalyst for neutralizing ions generated during electric precipitation. The discharge system and the catalyst can, for example, be preassembled as a unit, in particular to form an air post-treatment device. The discharge system is designed to neutralize electrostatically charged air ions before they are discharged into the surroundings in order to reduce the potentially negative health impact of ozone generated during electric precipitation. The discharge system may further be equipped such that the air is calmed by means of the discharge system, for example to reduce flow turbulence and/or to direct the air flow so that air can enter the catalyst in a directed, uniform and/or calmed manner, which increases the catalytic effect of the catalyst.

According to an exemplary further development of the present invention, the discharge system is electrically conductive and/or ozone resistant. Due to the ozone resistance, the service life of the discharge system and/or the ozone catalyst can be increased.

According to a further exemplary embodiment of the ambient air purifier according to the invention, the discharge system has an in particular multi-layered mesh or fabric, such as a wire mesh or a wire grid, a metallic mesh fabric or a non-metallic, electrically conductive plastic mesh fabric. For example, the plastic mesh can be coated with metal. It is also possible for the discharge system to consist of mesh or fabric, etc. Due to this form of the discharge system, its surface area can be maximized in a minimum of space, thereby maximizing its effectiveness. For example, several layers have proven to be advantageous, in particular at least two, three, four, five, six or seven layers. By multi-layered it is to be understood in particular that the layers are arranged one behind the other in the flow direction, for example in the sense of a series connection.

According to a further exemplary embodiment of the ambient air purifier according to the invention, the discharge system is formed with a fine mesh such that unhindered penetration of liquid and/or solid particles and/or air ions is prevented. This ensures that each particle and/or air ion touches the electrically leading surface of the discharge system at least once in order to be neutralized. According to another exemplary embodiment, the discharge system is formed to neutralize ions by impact. The discharge system can be designed in such a way that the neutralizing effect unfolds when ionized liquid and/or solid particles or air ions come into contact with it. In another exemplary further development, the discharge system is formed with a fine mesh such that the ratio of free passage area to material, in particular mesh, of the discharge system is between 5:1 and 10:1. The ratio has proven to be particularly advantageous, especially with regard to the compromise between high efficiency, which would be favored by a small passage area, and the lowest possible pressure loss, which would be favored by the largest possible passage area/volume.

In a further exemplary embodiment of the present invention, the discharge system may comprise a metal foam, in particular of nickel and/or copper, or a non-metallic, electrically conductive foam, in particular metal-coated foam.

According to an exemplary further development, the foam is formed with open pores. This ensures that air can flow through it as effectively as possible. For example, the foam can be a nickel-coated copper foam.

According to a further exemplary embodiment of the present invention, the counter electrode is wetted with liquid, in particular washed over with liquid. For example, an at least intermittently moving, in particular continuously flowing, liquid film may be formed on the counter electrode.

For example, the counter electrode can be sprayed with liquid on its surface facing the emission electrode or partially immersed in a liquid or gel bath in order to be continuously wetted with the liquid. For example, the counter electrode, in particular its surface, can be completely covered by an at least intermittently moving, in particular continuously flowing liquid film, wherein the liquid film can have a film thickness in the range of 0.1 mm to 1 mm, for example. The counter electrode can, for example, be inclined in relation to the direction of gravity so that the liquid flows along or down the counter electrode essentially under the influence of gravity. A liquid film can, for example, be understood as a closed, uninterrupted mass of liquid that essentially completely covers the counter electrode. In an exemplary further development, the ambient air purifier comprises a device for wetting the counter electrode with liquid. The liquid wetting device can be provided to realize the wetting of the counter electrode with liquid alone or together with the mist generator. The liquid wetting device can be formed as a nozzle or atomizer, for example. In an exemplary further development, the liquid wetting device is/are adapted to form an at least intermittently moving, in particular continuously flowing liquid film on the counter electrode. It may be provided that the liquid film has a film thickness in the range of 0.1 mm to 1 mm. In an exemplary further development, the electric precipitator and the liquid wetting device are coordinated in such a way that particles charged by the electric precipitator enter the liquid wetting the counter-electrode, in particular the liquid film formed on the counter-electrode. The particles electrically charged by the electric precipitator are attracted to its counter electrode and can thus be trapped in the liquid wetting and carried away by the liquid wetting, in particular the liquid film, in particular while the air flow cleaned of them continues separately and is finally dispensed back into the surroundings. The liquid wetting of the counter electrode also has the advantage that the counter electrode is cleaned, in particular washed, of contamination or deposits by means of the liquid. For example, the liquid wetting device can have operating states, such as an off state or a predetermined deactivated operating state, in which the counter electrode is not wetted. The liquid is generally a flowable rinsing and/or collecting medium, for example water, in particular also rainwater, a hygroscopic collecting material, such as sodium hydroxide dissolved in a liquid, a gel which is heated to a certain temperature, for example, so that a liquid aggregate state is reached, such as a wax or similar, an ionic liquid, such as molten or dissolved salts, or even highly viscous oils, which are for example mixed with electrically conductive particles, such as copper, are used. For example, the liquid can have a predetermined minimum electrical conductivity, for example of at least 0.005 S/m. The advantage of wetting the counter electrode with water is that the wetting can be generated particularly easily by the liquid wetting device and the mist generator together. In a further exemplary further development, the ambient air purifier can have a local liquid reservoir. By local is meant that the liquid storage tank is part of the ambient air purifier and/or is directly associated with it, in contrast to a separate liquid storage tank or a separate liquid supply. For example, the liquid storage tank is located below the electric precipitator and/or below the liquid wetting device. The liquid storage tank can be designed to supply the liquid wetting device and/or the mist generator with liquid or water. On the one hand, this results in a compact structure of the ambient air purifier, and on the other hand, the liquid can be returned to the liquid storage tank in a structurally simple manner using the weight force. In a further exemplary embodiment of the apparatus according to the invention, the liquid reservoir is integrated into a liquid circuit in such a way that the liquid, which may be contaminated with particles, can return to the liquid reservoir after wetting the counter electrode. The deposited particles can be entrained by the liquid and transported into the liquid reservoir where they are collected. Known electric precipitators generally have the disadvantage that they become clogged with deposited particles, i.e. contaminated, so that the precipitation effect of the electric precipitator is reduced. The wetting liquid prevents accumulation and deposition of precipitated particles on components of the electric precipitator and dissipates the particles in a targeted manner, namely into the liquid reservoir.

According to a further aspect of the present invention, which can be combined with the preceding aspects and exemplary embodiments, a method for ambient air purification is provided, in particular using an ambient air purifier according to the invention.

In the method according to the invention, liquid and/or solid particles are first electrically precipitated from air to be purified by generating ozone. Subsequently, at least part of the generated ozone is catalytically decomposed from air to be treated and ozone-enriched. The catalyst reduces the ozone concentration in the treated air by means of a catalytic process or reaction and thus reduces the health risk of the ambient air purifier according to the invention. The catalytic effect of the catalyst causes generated ozone to be split, resulting in oxygen molecules that are harmless to health. The air purifier or the ambient air purification method according to the invention is characterized in particular by a space-saving, flexible and cost-effective feature, wherein an ozone reduction of air is achieved at low cost, without maintenance and with a long service life, while at the same time achieving a high degree of electric precipitation.

Preferred embodiments are given in the sub-claims.

In the following, further properties, features and advantages of the invention will become clear by means of a description of preferred embodiments of the invention with reference to the accompanying exemplary drawings, in which:

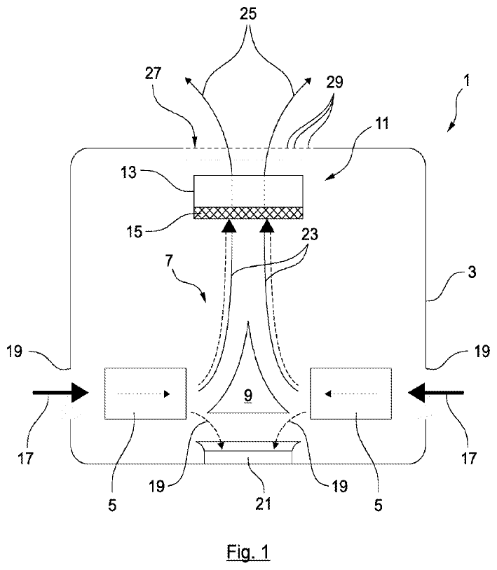

FIG. 1 a schematic principle sketch of an exemplary embodiment of an ambient air purifier according to the invention;

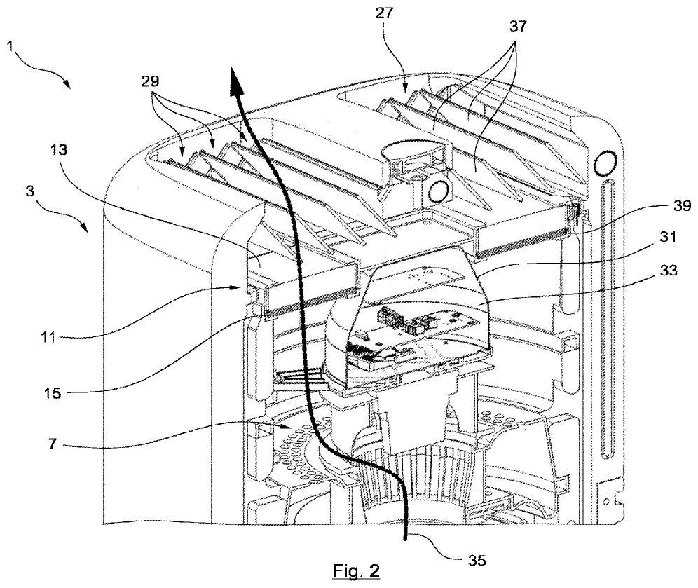

FIG. 2 a sectional view of a section of an exemplary embodiment of an ambient air purifier according to the invention; and

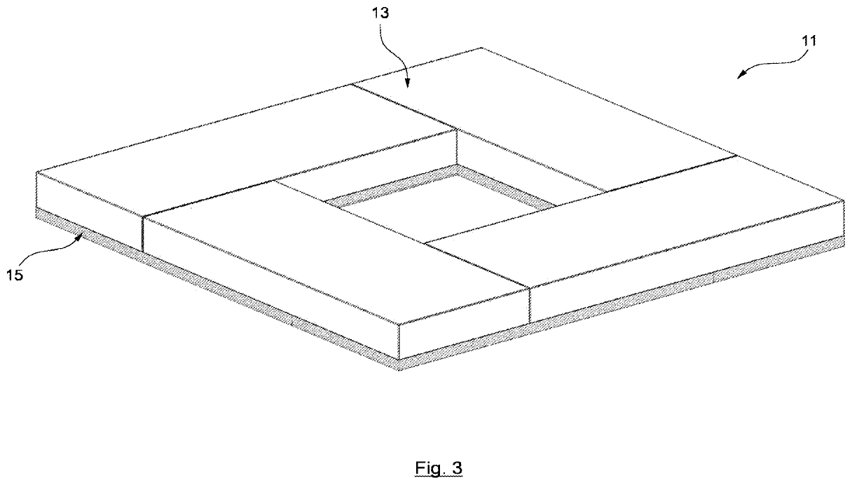

FIG. 3 a schematic perspective view of an ozone catalyst combined with a discharge system.

In the following description of exemplary embodiments, an ambient air purifier according to the invention is generally provided with the reference number 1. The ambient air purifier 1 can fulfill various functions depending on the operating state or by means of a simple design extension, namely air humidification, air purification, air washing and particle precipitation, which makes air purification particularly effective. For the description of exemplary embodiments with reference to FIGS. 1 to 3, it can be assumed by way of example that the ambient air purifier 1 is a floor-standing appliance or a small electrical appliance, which is primarily provided to be placed in building rooms, for example on a table or on a shelf.

FIG. 1 shows a schematic sketch of an exemplary embodiment of an ambient air purifier according to the invention to illustrate its mode of operation. The ambient air purifier 1 according to FIG. 1 essentially has the following main components: a housing 3; an electric precipitator 5; an air guide 7, which according to FIG. 1 has a central deflector body 9; and an air post-treatment system connected downstream of the electric precipitator 5 in the air flow direction, which according to FIG. 1 has an ozone catalyst 13 and a discharge system 15 connected upstream of the ozone catalyst 13 as viewed in the air flow direction. All components of the ambient air purifier 1 according to the invention are accommodated within the housing 3. In principle, air to be treated, which is generally provided with the reference numeral 17 and which contains liquid and/or solid particles, is fed into the interior of the housing 3 on the side via an air inlet 19 and fed to the electric precipitator 5. After the electric precipitation process, precipitated liquid and/or solid particles, which are generally marked with the reference numeral 20, are transported away into a collecting container 21 also arranged inside the housing 3, while the cleaned fresh air, which is marked with the reference numeral 23, is deflected via the air guide 7 in the direction of the air post-treatment system 11. After passing through the air post-treatment system 11, purified clean air with reduced ozone content, which is provided with the reference sign 25, leaves the housing 3 or the ambient air purifier 1 in the direction of the surroundings via an air outlet, which may, for example, have grid-shaped or lamellar outlet openings 29. FIG. 2 shows in more detail the air guide 7 and in particular the feeding of the purified and ozone-enriched air flow 23 into the air post-treatment device 21 and out of the apparatus 1 into the surroundings. A schematic illustration of the air post-treatment device 11 is shown in FIG. 3.

The section of the ambient air purifier 1 in FIG. 2 is to be understood downstream of the deflector body 9 shown in FIG. 1. According to the embodiment in FIG. 2, the ambient air purifier 1 also comprises electronics 33 housed in an electronics housing 31, which is arranged in particular centrally and in which, for example, the high-voltage device for the electric precipitator 5 is housed. The solid arrow with the reference sign 35 schematically indicates the air flow direction downstream of the deflector body 9. The air post-treatment system 11 is shown downstream of the electric precipitator 5 and upstream of the air outlet 27, which in the embodiment shown in FIG. 2 consists, for example, of a sandwich structure of a discharge system 15 and an ozone catalyst 13. The air outlet 27 is formed in FIG. 2 by a plurality of lamellas 37 arranged at a distance from one another, which leave free spaces between them for the air outlets 29, through which air 35 can pass from the air treatment device 1 into the surroundings. As can be seen schematically in FIG. 2, the air post-treatment system 11 is attached to the housing 3 of the ambient air purifier 1 via a clamp-like housing mount 39 and held in position.

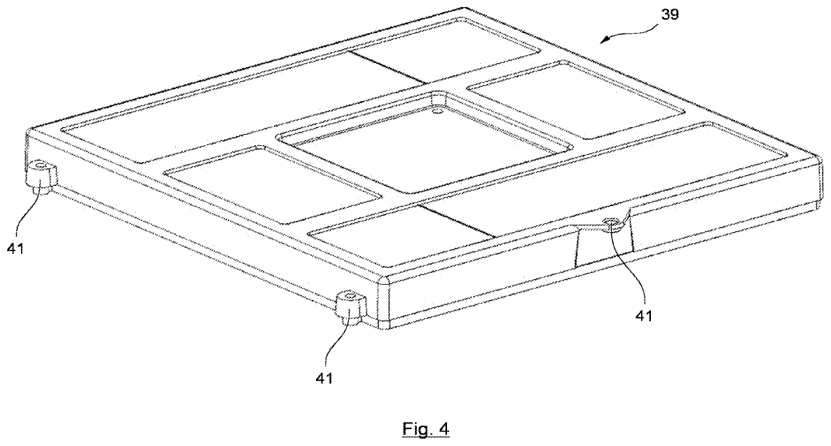

The housing mount 39 is also shown schematically in perspective view in FIG. 4. Via the housing mount 39, the ozone catalyst 13 and the discharge system 15 are protected against the surroundings and, in particular, sealed against liquids. The housing mount 39 comprises several mounting interfaces 41 via which the housing mount 39 can be connected to the housing 3 of the ambient air purifier 1, for example by screwing.

FIG. 3 shows the schematic series connection or sandwich structure consisting of a discharge system 15 connected upstream in the flow direction and an ozone catalyst 13 connected downstream in the flow direction. The air post-treatment system 11 is composed of four individual modules of an ozone catalyst 13 and a discharge system 15 to form a rectangular structure with the exemplary embodiments of FIGS. 2-4. For example, the individual modules are dimensioned such that they form a square in the assembled form. The air post-treatment system 11 including the housing mount 39 can thus be integrated into the ambient air purifier 1 as a unit, as well as disassembled if replacement is necessary. With regard to the individual components ozone catalyst 13 and discharge system 15 and their embodiments, reference is made to the detailed preceding description.

The features disclosed in the above description, the figures and the claims can be of importance both individually and in any combination for the realization of the invention in the various embodiments.

### REFERENCE SIGN LIST

1 ambient air purifier
3 housing
5 electric precipitator
7 air guide
9 deflector body
11 air post-treatment device
13 ozone catalyst
15 discharge system
17 air to be treated
19 air inlet
20 precipitated particles
21 collection container
23 purified fresh air
25 clean air post-treated with the ozone catalyst
27 air outlet
29 air outlet
31 electronics housing
33 electronics
35 air flow direction downstream of deflection body
37 lamella
39 housing mount
41 mounting interface

1. An ambient air purifier (1) comprising:
an electric precipitator (5) having a counter electrode and an emission electrode and is designed to precipitate liquid and/or solid particles from air to be purified while generating ozone; and
a catalyst (13) arranged downstream of the electric precipitator (5) in the air flow direction for decomposing at least part of generated ozone.

2. The ambient air purifier (1) according to claim 1, further comprising an air guide (7) configured to guiding air to be treated and ozone-enriched from the electric precipitator (5) to the catalyst (13) wherein in particular the air guide (7) is formed in such a way that air is deflected on its way to the catalyst, in particular by at least 10°, at least 30°, 45°, 60° or by about 90°, wherein in particular the air guide (7) comprises a deflector body which is designed to deflect air treated by the electric precipitator (5) against the direction of gravity.

3. The ambient air purifier (1) according to one of the preceding claims, wherein the catalyst (13) comprises a reticular carrier which is provided with a catalytically active coating, such as a noble metal or manganese dioxide coating.

4. The ambient air purifier (1) according to claim 3, wherein the reticular carrier is a fine-meshed expanded metal or an electrically conductive plastic net.

5. The ambient air purifier (1) according to claim 3 or 4, wherein the coating is applied by means of a gas- or solution-based deposition process, in particular by means of wet-chemical deposition, chemical vapor deposition (CVD) or physical vapor deposition (PVD) or is sputtered on.

6. The ambient air purifier (1) according to one of the preceding claims, further comprising a discharge system (15) arranged downstream of the electric precipitator (5) in the air flow direction and upstream of the catalyst (13) for neutralizing ions generated during electric precipitation.

7. The ambient air purifier (1) according to claim 6, wherein the discharge system (15) is electrically conductive and/or ozone resistant.

8. The ambient air purifier (1) according to claim 6 or 7, wherein the discharge system (15) having an in particular multi-layered mesh or fabric, such as a wire mesh or a wire grid, a metallic mesh fabric or a non-metallic, electrically conductive plastic mesh fabric.

9. The ambient air purifier (1) according to one of claims 6 to 8, wherein the discharge system (15) is formed with such a fine mesh such that unhindered passage of liquid and/or solid particles and/or air ions is prevented.

10. The ambient air purifier (1) according to one of claims 6 to 9, wherein the discharge system (15) is formed to neutralize ions by impact.

11. The ambient air purifier (1) according to one of claims 6 to 10, wherein the discharge system (15) is formed with such a fine mesh such that the ratio of free passage area to material of the discharge system is from 5:1 to 10:1.

12. The ambient air purifier (1) according to one of claims 6 to 11, wherein the discharge system (15) having a metal foam, in particular made of nickel and/or copper, or a non-metallic, electrically conductive foam, in particular metal-coated foam.

13. The ambient air purifier (1) according to claim 12, wherein the foam is open-pored.

14. The ambient air purifier (1) according to one of the preceding claims, wherein the counter electrode is wetted with liquid, in particular washed over with liquid, wherein in particular an at least intermittently moving, in particular continuously flowing, liquid film is formed on the counter electrode.

15. A method for ambient air purification, in particular by means of an ambient air purifier according to one of claims 1 to 14, in which:
first, liquid and/or solid particles are electrically precipitated from air to be purified while generating ozone; and
subsequently, at least a portion of the generated ozone is catalytically decomposed from the to be treated and ozone-enriched air.
